(19) United States
(12) Patent Application Publication
(10) Pub. No.: US 2008/0001128 A1
(43) Pub. Date: Jan. 3, 2008

(54) Flexible Wall Having Fire Resistant Properties

(75) Inventor: Simon Goldberg, Brussels (BE)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: GOLDFIRE SPRL, BRUSSELS BE (BE)

(21) Appl. No.: 10/587,510

(22) PCT Filed: Jan. 11, 2005
(86) PCT No.: PCT/EP05/50101

§ 371 Date: May 25, 2007

(30) Foreign Application Priority Data
Jan. 27, 2004 (EP) 04100280.9

(51) Int. Cl. A62C 2/10

(52) U.S. Cl. 252/604; 57/904

(57) ABSTRACT

The invention concerns a fire-resistant flexible wall, comprising a first surface facing towards the fire, and an insulating material layer provided between a basalt fabric layer and a second surface opposite the first surface. The wall may comprise a second basalt fabric layer provided between the insulating material layer and the second surface. The wall may further comprise a continuous metal layer. Each layer plays a specific role (mechanical or fire resistance, thermal insulation, smoke shield or gas shield) and enables walls of large dimensions and high efficiency to be produced.

### FIELD OF THE INVENTION

In the field of fire-resistant walls, a distinction may be made between rigid walls and flexible walls. Rigid walls are made essentially of rigid materials and generally have little deformability.

The invention relates to fire-resistant flexible walls, that is, walls made essentially of flexible materials. This property of flexibility allows them to be deployed and folded away easily, and in particular without requiring any segmentation of the wall. Such segmentation is adopted in certain rigid walls, such as those constructed by assembling a number of rigid sections hinged together to form a roller shutter.

The flexible walls discussed in the present text may for example form a retractable curtain, or a roller blind, or be installed in a fixed manner.

Fire resistance is the result of the action of a material which, when interposed between the fire and a zone to be protected, prevents or reduces the propagation of fire towards the zone to be protected. The wall therefore comprises a first surface presented to a fire area and a second surface, on the opposite side from the first surface and therefore presented to the zone to be protected, termed the second surface. If a fire breaks out in the fire area, the temperature of this second surface must be below a limit in order not to propagate the fire or not to cause burns if a person touches it.

### THE PRIOR ART

Flexible walls of this kind are known, as for example from FR 2 300 582, in which a curtain descends vertically in the event of a fire and acts as a flexible fire-break wall. This curtain is made of one or two flexible nets. In the event of a fire, a mixture of water and a foaming agent is trickled over the net and, if applicable, between the two nets.

It is therefore the water which acts simultaneously as a fire break, a smoke shield and a means of protecting the net from the fire.

There are many problems with the use of water-based mixtures. The installation is complex because it requires a tank and a pump. The tank, whose volume is sometimes considerable, requires permanent maintenance. Also, the use of water is often incompatible with the electrical, electronic or computer equipment present in many rooms requiring protection.

At the same time, if fire protection is required for a complex shape, such as an aircraft, ship or helicopter engine, or the interior of a small room, it becomes extremely difficult or extremely expensive to implement this technique using an aqueous mixture.

### SUMMARY OF THE INVENTION

One object of the invention is to provide a fire-resistant flexible wall that is simple to use.

Another object of the invention is to provide a fire-resistant flexible wall that is easily adaptable to complex shapes.

Another object of the invention is to provide a fire-resistant flexible wall capable of being made in large sizes and with good mechanical strength.

To these ends, the flexible wall according to the invention is characterized in that it incorporates a flexible insulating material layer between a first basalt fiber fabric layer and the second surface. This flexible insulating material has thermal insulation properties.

Basalt fiber is an inherently fire-resistant material. Once woven, this fiber will be used as the basis for a fire-resistant flexible wall that is simple to use without resorting to aqueous fluids.

The result of using a basalt fiber fabric layer combined with a flexible insulating material layer is a wall that remains flexible. Without resorting to aqueous fluids, it is possible to use this flexible wall according to the invention to cover any shape with complex contours and protect either the inside or the outside. The flexible wall can thus cover rare or costly objects such as works of art, jewels or archives. Motor vehicles can also be wrapped with a fire-resistant blanket. Conversely, a jacket can be made to fit around the contours of a complex object that is a source of heat, such as a heat engine.

The weaving of basalt fibers gives the wall according to the invention a very noticeable increase in mechanical strength. The tensions to which the wall is subjected are absorbed by this basalt fiber fabric layer and distributed throughout the material.

In addition, the mechanical strength of the basalt fiber fabric makes it possible to produce top-hung fire-resistant walls that do not tear or break under their own weight, even in very large sizes. This mechanical strength could not be achieved with unwoven basalt fibers.

An additional advantage is that the basalt fiber fabric has a low coefficient of friction and good abrasion resistance, which is helpful when it comes to winding and unwinding such a wall.

The fact that a flexible insulating material layer is embedded between the first basalt fiber fabric layer and the second surface reduces the transmission of heat to the second surface, in the event of a fire breaking out in the fire area. It is essentially the fabric layer which will provide the fire resistance and essentially the insulating material layer which will prevent the transmission of heat.

Another object of the invention is to provide a wall that can face in either direction. The fire-resistant flexible wall is sometimes used to separate two zones, so as to protect one zone if fire breaks out in the other zone, and vice versa.

To this end, a preferred embodiment of the invention is characterized in that the wall incorporates a second basalt fiber fabric layer between the flexible insulating material layer and the second surface.

If fire breaks out on the side next to the second surface, the zone adjacent to the first surface is protected by the presence of a flexible insulating material layer arranged in front of a basalt fiber fabric layer.

Yet another object of the invention is to provide a fire-resistant flexible wall having barrier properties against smoke and/or gases given off by the combustion.

To this end, another preferred embodiment of the invention is characterized in that the wall incorporates a flexible continuous metal layer. This metal layer will act as the smoke shield and/or as the gas shield.

### FIGURES AND DETAILED DESCRIPTION OF THE INVENTION

These and other aspects of the invention will be clarified in the detailed description of certain embodiments of the invention, reference being made to the following figures:

FIG. 1 shows an example of a fire-resistant flexible wall; the wall is hung from and fixed to a horizontal shaft;

FIG. 2 is a cross section A-B through the wall shown in FIG. 1 in one embodiment of the invention;

FIG. 3 is a cross section A-B through the wall shown in FIG. 1, in a preferred embodiment of the invention; and

FIG. 4 is a cross section A-B through the wall shown in FIG. 1, in another preferred embodiment of the invention.

The figures are not drawn to scale. Generally speaking, similar parts are indicated by similar references from one figure to another.

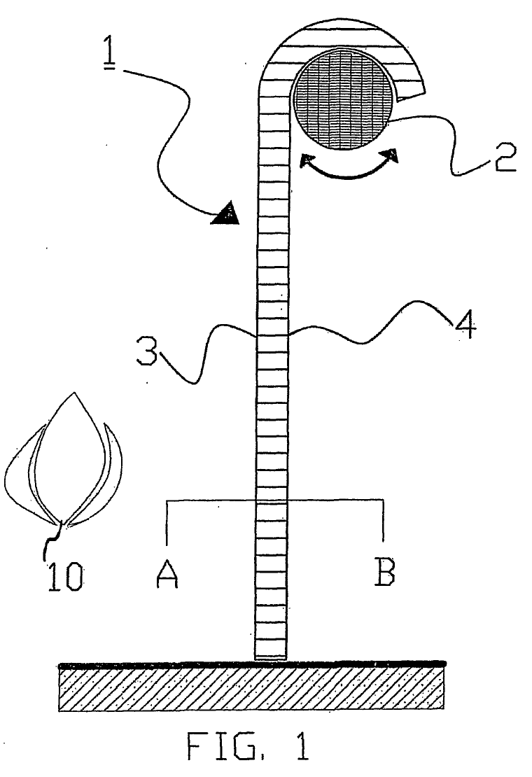

FIG. 1 is a diagram of a fire-resistant flexible wall (1) hung from and fixed to a horizontal shaft (2) which can be rotated to wind the wall (1). This wall (1) has a first surface (3) designed to be presented to the fire area (10) and a second surface (4) which is on an opposite side from the first surface (3). The wall (1) performs its protective role against the fire only when it is unwound, as illustrated in FIG. 1. A section A-B through the wall (1) shown in FIG. 1 will provide us with the various different embodiments of a wall (1) according to the invention.

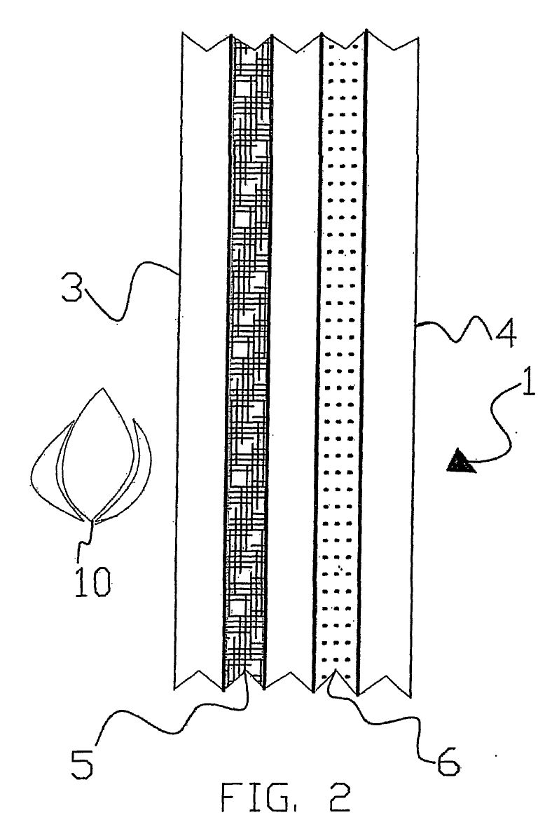

An initial embodiment of a fire-resistant flexible wall according to the invention is detailed in FIG. 2. This section shows a first layer composed of a basalt fiber-based fabric (5).

The basalt fibers may for example be joined together in the form of yarns, tapes, filaments or strips woven in the conventional way (at right angles), in chevrons (serge) or by another weaving technique.

“Tape” here means a thin, narrow band of flexible material. By for example bringing the fibers together into a tape, the tapes can be woven to give a fabric with a thickness of approximately 1 mm or less, and a basis weight of 160 to 1000 gsm.

FIG. 2 also shows a layer of flexible insulating material (6) such as mineral wool, glass wool or rock wool. An example of a glass wool that can be used is PROMAGLAF HTI 1100. This insulating material layer (6) is placed between the first basalt fiber fabric layer (5) and the second surface (4). This layer (6) reduces very substantially the transmission of heat from the first surface (3) to the second surface (4).

The layers (5) and (6) are joined together by stitching. The stitching is preferably performed with basalt yarn. For example, a 100-tex basalt yarn can be used. This basalt yarn can withstand temperatures of more than 1000° C.

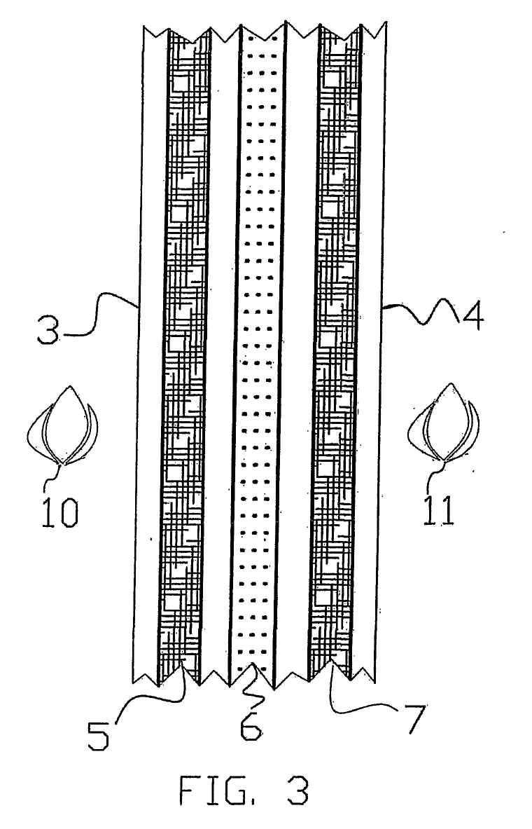

In one preferred embodiment of the wall (1), presented in FIG. 3 on the same section A-B as marked in FIG. 1, a second layer of basalt fiber fabric (7) is incorporated between the flexible insulating material layer (6) and the second surface (4). This gives a wall (1) capable of withstanding fire on both sides, both area (10) and area (11), while still having the insulating effect of the flexible insulating material layer (6).

In another preferred embodiment of the wall (1), the wall (1) incorporates a flexible continuous metal layer (8). This metal layer (8) is preferably accompanied by a basalt fiber fabric layer (5), (7). The metal layer (8) may however also accompany the flexible insulating material layer (6).

This metal layer (8) provides a smoke shield and/or gas shield effect, thereby reducing in particular the risk of poisoning or loss of visibility for people located adjacent to the second surface (4) while reflecting some of the heat radiation.

The metal layer (8) is preferably a sheet of aluminum, stainless steel, titanium or any other metal or metal alloy. An example that may be used is an aluminum sheet with a thickness of approximately 1 mm or less.

If a basalt fiber fabric layer (5), (7) is attached to the metal layer (8), they can be joined together by means of adhesive. Adhesive is preferred to stitching because it avoids perforating the metal layer (8), on which the smoke-shield and/or gas-shield effect depends.

An inorganic adhesive such as a sodium silicate-based adhesive is preferred.

It is of course possible to combine the valuable properties of the metal layer (8) with those of the insulating layer (6). This combination will give the wall (1) its heat insulating quality in addition to the smoke shield and/or gas shield properties. By combining layers (6) and (8) with the layers of basalt fiber fabric (5), (7), highly effective fire-resistant flexible walls (which will be referred to as multilayer walls) can be produced.

It will be obvious that the number of component layers of this “multilayer” fire-resistant flexible wall (1), the composition of these layers, and their respective thicknesses will be selected as appropriate to the type of fire resistance which it is aimed to achieve.

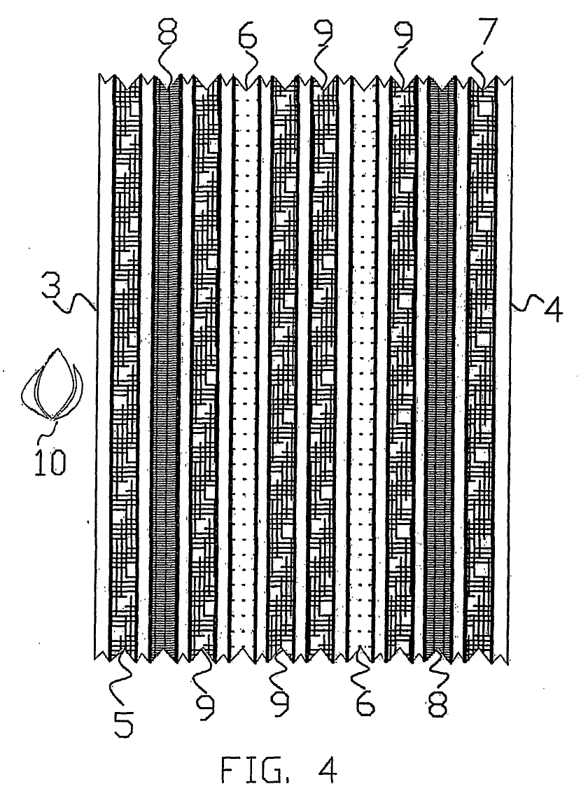

FIG. 4 gives an example of a fire-resistant flexible wall (1) capable of being wound around a horizontal shaft (2). This is another example shown on the section A-B as marked in FIG. 1. Beginning with the first surface (3) and proceeding towards the second surface (4), the following may be distinguished in succession:
a first basalt fiber fabric layer (5) bonded to a flexible continuous metal sheet (8);
two basalt fiber fabric layers (9), one on either side of a flexible insulating material layer (6), the various layers being joined together by stitching;
two basalt fiber fabric layers (9), one on either side of a flexible insulating material layer (6), the various layers being joined together by stitching; and
a flexible continuous metal sheet (8) bonded to a second basalt fiber fabric layer (7).

This wall (1) can be made from the materials described above and its components joined together in the manner described above. If need be, the final joining of the components of the wall (1) (notably to finish the side and bottom edges properly) is also done by stitching with basalt yarn, as described above.

The thickness of this wall (1) is from 30 to 80 mm, which allows it to be easily wound onto a horizontal shaft (2) mounted for example close to the ceiling. This shaft (2) may be hand operated or driven by an electric motor.

The wall (1) according to the invention, with a structure which could be described as symmetrical, forms a barrier to fire in both directions. It combines a number of advantages already noted above:
the mechanical strength of the various basalt fiber fabric layers (5), (7), (9) distributes the loads and the mechanical tensions; this strength is great enough to enable walls (1) to be made in heights of for example 10 m and width of 10 m;
the flexible insulating material layers (6) prevent the second surface (4) from reaching too high a temperature; this effect is also observed in the other direction;
the flexible continuous metal layers (8) fulfill their smoke-shield and/or gas-shield roles;
the basalt fiber fabric layers (5), (7), (9) and the flexible continuous metal layers (8) slide easily over each other, making them easy to wind up.

The respective thicknesses of the various layers are less than 1 mm for the basalt fiber fabric, less than 1 mm for the aluminum, and 20 mm for the insulating material. This insulating material is generally available in thicknesses of between 15 and 30 mm.

This same wall (1) has withstood a fire test in accordance with standard NBN 713.020 for 54 min. In other words, a wall (1) was assembled in accordance with FIG. 4, having dimensions of 2 m by 1.5 m (height×width) for the requirements of the test. The wall (1) was subjected on its first surface (3) to a temperature rising progressively from the ambient level of the test laboratory (20° C.). The temperature had reached nearly 1000° C. by the end of 54 min. At this point the average and surface temperature of the second surface (4) had not increased more than 140° C. above the initial temperature. This implies that it could achieve class “Rf ½ h” according to standard NBN 713.020, which requires a minimum fire resistance of 30 min. However, the resistance of this wall (1) according to the invention is already close to class “Rf 1 h”, which is 1 hour.

It will be obvious to any person skilled in the art that the present invention is not limited to that which has been disclosed and described in particular and above. The invention lies in the possession of all novel features and in each combination of these features. Reference numbers in the claims do not limit the scope of protection of the claims. The use of the verbs “comprise, possess or incorporate” and their conjugated forms does not exclude the presence of other elements than those enumerated in the claims. The use of the words “a/an/one” before an element does not exclude the presence of a plurality of this element.

The present invention has been described in terms of specific embodiments which are an illustration of the invention and must not be considered to limit it.

1. A fire-resistant flexible wall having a first surface designed to be presented to a fire area and a second surface on the opposite side from the first surface, wherein the said wall includes a flexible insulating material layer between a first basalt fiber fabric layer and the second surface.

2. The fire-resistant flexible wall as claimed in claim 1, further including a second basalt fiber fabric layer between the flexible insulating material layer and the second surface.

3. The fire-resistant flexible wall as claimed in claim 1, wherein the first basalt fiber fabric layer and the flexible insulating material layer are joined together by stitching.

4. The fire-resistant flexible wall as claimed in claim 2, wherein the second basalt fabric layer and the flexible insulating material layer are joined together by stitching.

5. The fire-resistant flexible wall as claimed in claim 3 or 4, wherein the stitching is done with basalt yarn.

6. The fire-resistant flexible wall as claimed in claim 1 or 2 wherein each of the basalt fiber fabric layers comprises a fabric made of yarn, tapes, strips or filaments of basalt.

7. The fire-resistant flexible wall as claimed in claim 1 or 2, further including a flexible continuous metal layer.

8. The fire-resistant flexible wall as claimed in claim 7, wherein the first or second basalt fiber fabric layer and the flexible continuous metal layer are joined together by means of an adhesive.

9. The fire-resistant flexible wall as claimed in claim 8, wherein the adhesive is sodium silicate-based.

10. The fire-resistant flexible wall as claimed in claim 7, wherein the flexible continuous metal layer includes a metal or an alloy of metals selected from aluminum, titanium, and stainless steel.
